(19) United States
(12) Patent Application Publication
(10) Pub. No.: US 2015/0263775 A1
(43) Pub. Date: Sep. 17, 2015

(54) Cellular Phone Power Pack Charger

(71) Applicant: Luis Vila, Greer, SC (US)

(72) Inventor: Luis Vila, Greer, SC (US)

(21) Appl. No.: 14/214,066

(22) Filed: Mar. 14, 2014

(51) Int. Cl. H04B 1/38; H04M 1/02

(52) U.S. Cl. CPC H04B 1/3883; H04M 1/0262; H04M 2001/0204

(57) ABSTRACT

A cellular phone power case that does not require a power cord to recharge the power within the case, the power case comprises: A cellphone case, the cellphone case has a front, a back, a top, a bottom, a left and a right side, the front of the cellphone case defines a plurality of battery holders, each battery holder is adjacent to each corner of the cellphone case, the top side of the case defines a plurality of LED apertures, the left, right, and bottom sides of the case define a restraining arm; LED lights attached to the top of the cellphone case so that the plurality of LED apertures is aligned to the LED lights; a power adapter attached to the bottom restraining arm; a prong housing attached to back of the cellphone case, a pair of prongs that are a housed within the prong housing so that the prongs can be in either an extended or retracted position; a battery, the battery is secured within the plurality holders; a battery cover that is attached to the front of the cellphone case after the battery is inserted within the cellphone case; and an integrated circuit that is attached to the front of the cellphone case, the integrated circuit is wired to the battery, the LED lights, the prongs, and the power adapter.

### BACKGROUND

The present invention is directed to a cellular phone power case that does not need a power cord to charge the power case and that has an integrated circuit that feeds power to the cellphone that is attached to the power case.

A cellular phone power case is used to store an additional battery backup for a cellular phone and provide a protective cover for the cellular phone.

Cellular phone power cases are devices that are needed by cellular phone users that use cellular phones frequently, for each use of their cellular phone drains the battery of the cellular phone.

The problem with cellular phone power cases presently in the market is that they require a user of the power case to carry a power cord to charge the power case. If the power cord is misplaced or forgotten, then the power case cannot be charged. This can be disastrous for a cellular phone user that uses a cellular phone frequently, for when the battery of the cellular phone and the power case dies, the cellular phone becomes inoperable.

For the foregoing reason there is a need for a cellular phone power case that does not require a power cord to be charged and that has an integrated circuit that feeds power to a cellphone that is attached to the power case.

### SUMMARY

The present invention is directed to a cellular phone power case that does not require a power cord to be charged and that has an integrated circuit that feeds power that is attached to the power case.

The cellular phone power case of the present invention comprises of an all in one design that utilizes a plug that can extended into a plugging position and retracted into an unplugging position. The power case uses a lithium battery to store power and an integrated circuit to monitor and distribute the power stored within a power case battery that is housed within the power case to a cellphone.

When the power case is in the plugging position, the power case can be directly connected to a power outlet. When the power case is in the retracted the position, the phone can be stored or carried by the user in the same manner that cellular phone cases are stored or carried.

An object of the present invention is to provide a cellular phone user with a power case that will store a backup battery for his or her cellular phone.

Another object of the present invention is to provide a user of the cellular phone with a power case that will allow the user to monitor the battery life remaining in the power case.

A further object of the present invention is to provide a user with a power case that does not require a power cord to charge the power case.

Yet a further object of the present invention is to provide a power case that uses an integrated circuit to monitor and distribute power from a power case to a cellular phone.

Still a further object of the present invention is to provide a power case that will alert a user of the combined battery life available to him or her when using the power case and a cellphone tandem.

### DRAWINGS

With the above and other related objects in view, the invention consists in the details of construction and combination of parts as will be more fully understood from the following description, when read in conjunction with the accompanying drawings in which:

FIG. 1 shows a perspective front view of the cellphone power case of the present invention;

FIG. 2 shows a front perspective exploded view of the present invention;

FIG. 3 shows a perspective rear view of the cellular phone power case;

FIG. 4a-4b shows a perspective rear view of the present invention showing the prongs of the present invention in an extended and retracted provision respectively;

FIG. 5 shows a diagram of how one embodiment of the present invention is wired;

FIG. 6 shows a perspective of a removable belt clip that is used with the present invention; and

FIG. 7 shows an exploded view of how the removable belt clip is attached to the present invention.

### DESCRIPTION

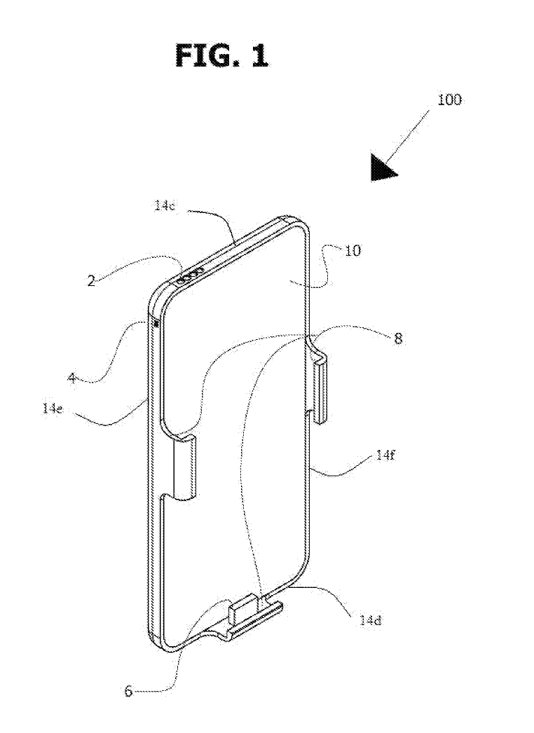

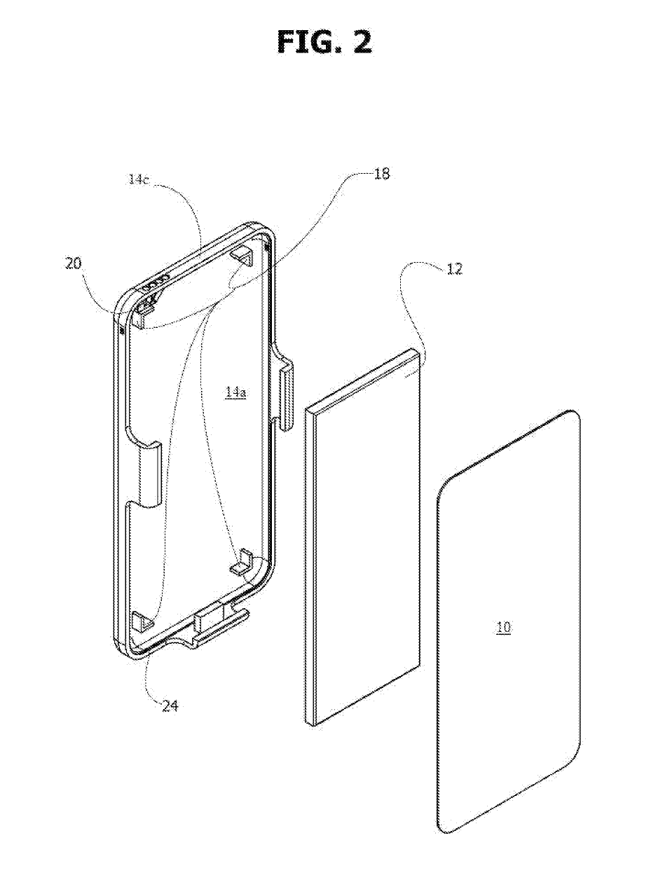

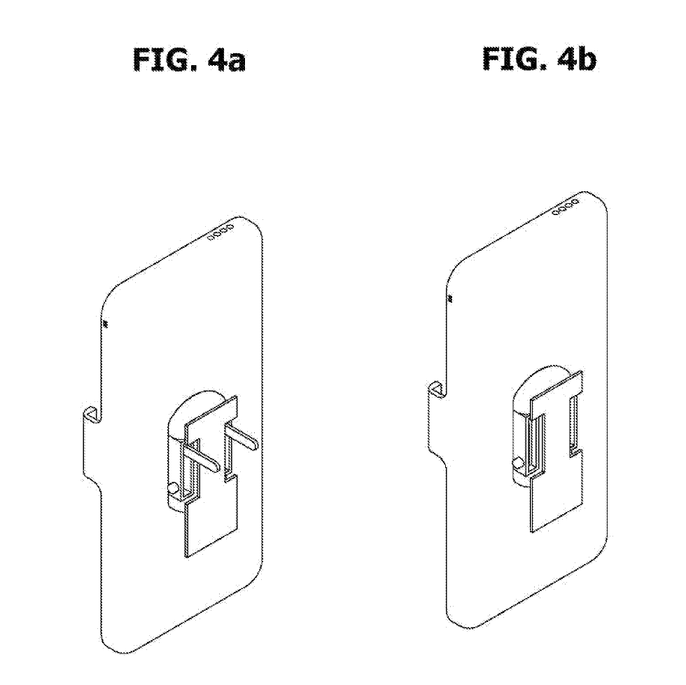

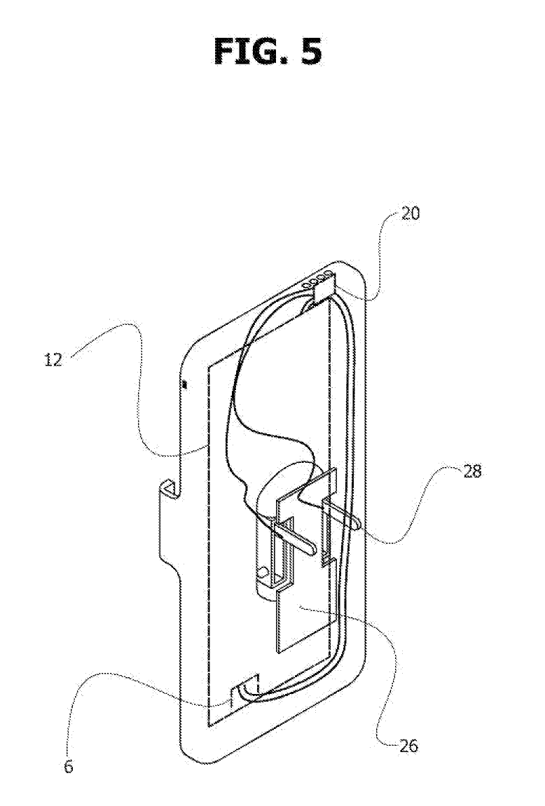

As seen in FIGS. 1-5, a cellular phone power case 100 that does not require a power cord to recharge the power within the case, the power case 100 comprises: A cellphone case 14, the cellphone case has a front 14a, a back 14b, a top 14c, a bottom 14d, a left 14e and a right side 14f, the front 14a of the cellphone case defines a plurality of battery holders 18, each battery holder 18 is adjacent to each corner of the cellphone case (not numbered in Figures), the top side 14c of the case defines a plurality of LED apertures 2, the left 14e, right 14f, and bottom sides 14d of the case define a restraining arm 8; LED lights 2 (the number 2 shall be used to identity the LED apertures and the LED lights) attached to the top of the cellphone case 14c so that the plurality of LED apertures 2 is aligned to the LED lights 2; a power adapter 6 attached to the bottom restraining arm 8; a prong housing 30 attached to back of the cellphone case 14b, a pair of prongs 28 that are a housed within the prong housing 30 so that the prongs 28 can be in either an extended or retracted position; a battery 12, the battery 12 is secured within the plurality of battery holders 18; a battery cover 10 that is attached to the front of the cellphone case 14a after the battery 12 is inserted within the cellphone case 14; and an integrated circuit 20 that is attached to the front of the cellphone case 14a, the integrated circuit 20 is wired to the battery 12, the LED lights 2, the prongs 28, and the power adapter 6.

as seen in FIG. 1, in an embodiment of the present invention, the cellular phone power case 100 further defines a vent hole 4 in the left side 14c of the cellphone case 14.

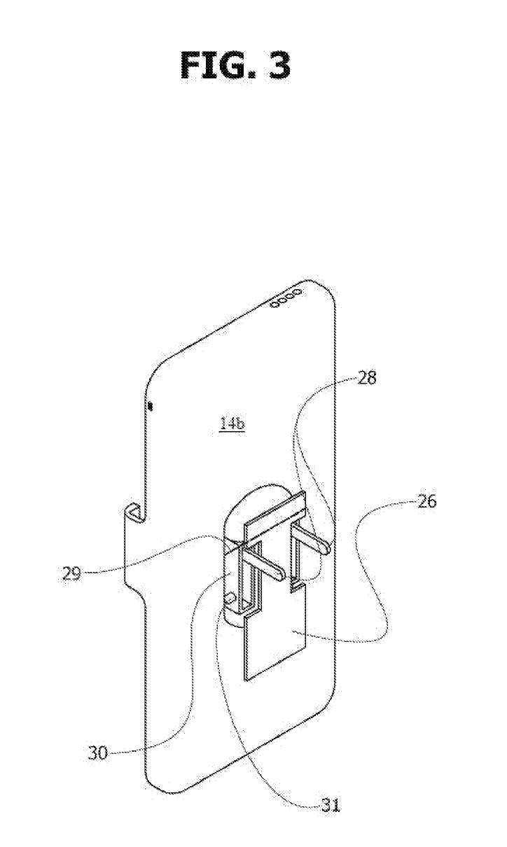

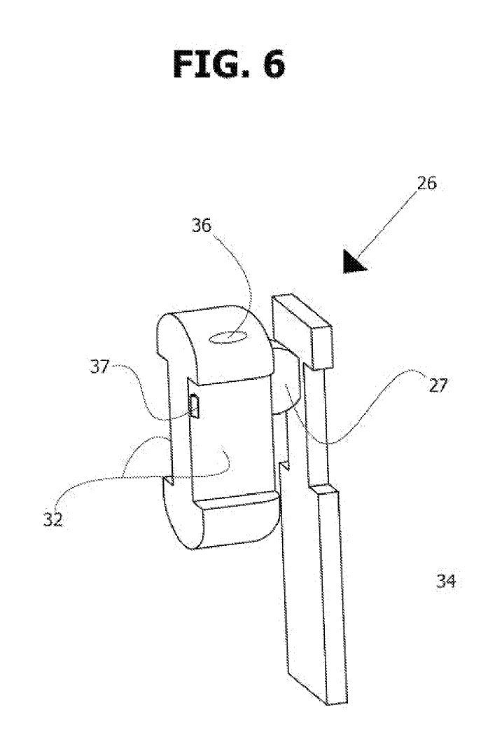

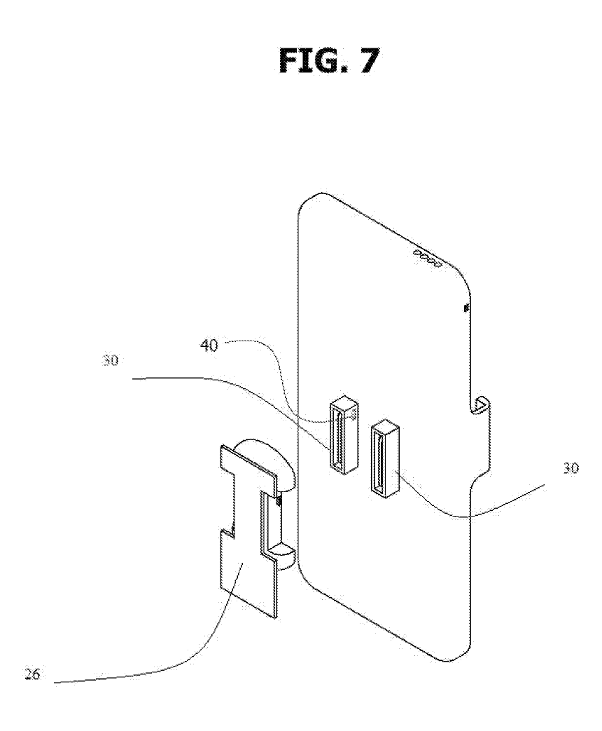

As seen in FIGS. 3-6, in another embodiment of the present invention, the cellular phone power case 100 further comprises of a removable belt clip 26, the belt clip attaches to the prong housing 30 of the cellular phone power case 100. As seen in FIG. 7, in still a further embodiment, the belt clip 26 is I-shaped so that when it attaches to the prong housing 30, the prongs 28 of the cellular phone power case 100 are not obstructed when in extended position, thereby allowing the cellular phone power case 100 to be charged when the belt clip 26 is attached to the prong housing 30.

The battery 12 of the present invention may be either a lithium polymer, lithium ion battery, or any other battery that may be used to hold a battery charge.

The integrated circuit 20 of the present invention shall monitor and distribute the power stored within the battery 12 that is housed within the cellular phone power case 100 to a cellphone.

An advantage of the present invention is that it provides a cellular phone user with a power case that stores a backup battery for his or her cellular phone.

Another advantage of the present invention is that it provides a user of the cellular phone with a power case that allows the user to monitor the battery life remaining in the power case.

A further advantage of the present invention is that it provides a user with a power case that does not require a power cord to charge the power case.

Yet a further advantage of the present invention is that it provides a power case that uses an integrated circuit to monitor and distribute power from a power case to a cellular phone.

Still a further object of the present invention is that it provides a power case that alerts a user of the combined battery life available to him or her when using the power case and a cellphone in tandem.

Although the present invention has been described in considerable detail in reference to preferred versions, other versions are possible. Therefore, the spirit and scope of the appended claims should not be limited to the description of the preferred versions contained herein.

What is claimed is:

1. A cellular phone power case that does not require a power cord to recharge the power within the case, the power case comprises:
A cellphone case, the cellphone case has a front, a back, a top, a bottom, a left and a right side, the front of the cellphone case defines a plurality of battery holders, each battery holder is adjacent to each corner of the cellphone case, the top side of the case defines a plurality of LED apertures, the left, right, and bottom sides of the case define a restraining arm;
LED lights attached to the top of the cellphone case so that the plurality of LED apertures is aligned to the LED lights;
a power adapter attached to the bottom restraining arm;
a prong housing attached to back of the cellphone case, a pair of prongs that are a housed within the prong housing so that the prongs can be in either an extended or retracted position;
a battery, the battery is secured within the plurality holders;
a battery cover that is attached to the front of the cellphone case after the battery is inserted within the cellphone case; and
an integrated circuit that is attached to the front of the cellphone case, the integrated circuit is wired to the battery, the LED lights, the prongs, and the power adapter.

2. The cellular phone power case of claim 1, further defines a vent hole in the left side of the cellphone case.

3. The cellular phone power case of claim 2, further comprising of a removable belt clip, the belt clip attaches to the prong housing.

4. The cellular phone charger of claim 3, wherein the belt clip is I-shaped so that when it attaches to the prong housing, the prongs of the cellular phone power case are not obstructed when in the extended position, thereby allowing the cellular phone power case to be charged when the belt clip is attached to the prong housing.
